(19) United States
(12) Patent Application Publication
(10) Pub. No.: US 2014/0117863 A1
(43) Pub. Date: May 1, 2014

(54) Strobe Device and Electric Power Supply Method Therefor

(71) Applicant: Nissin Industries Ltd., (unknown)

(72) Inventor: Han Wu HE, North Point (CN)

(73) Assignee: Nissin Industries Ltd.

(21) Appl. No.: 14/059,535

(22) Filed: Oct. 22, 2013

(30) Foreign Application Priority Data
Oct. 31, 2012 (JP) 2012-240168

(51) Int. Cl. H05B 37/02

(52) U.S. Cl. CPC H05B 37/0209
USPC 315/173

(57) ABSTRACT

A strobe device configured to be connectable with an external power supply device to receive electric power for light emission from outside, includes: a main capacitor for storing electric charge for light emission; an internal power supply for supplying electric power to the main capacitor; and a power supply control unit configured to control supply of electric power to the main capacitor. The power supply control unit is configured to determine whether electric power is being supplied to the main capacitor from outside based on a change in a charge state of the main capacitor after a discharge of the main capacitor for light emission, and when it is determined that electric power is being supplied from outside, prevent the internal power supply from supplying electric power.

### CROSS-REFERENCE TO RELATED APPLICATIONS

This application claims the priority of Japanese Patent Application No. 2012-240168, filed in the Japanese Patent Office on Oct. 31, 2012, the disclosure of which is hereby incorporated by reference herein in its entirety for all purposes.

### TECHNICAL FIELD

The present invention relates to a strobe device, and particularly to a strobe device capable of receiving electric power for light emission from outside and an electric power supplying method therefor.

### BACKGROUND OF THE INVENTION

Conventionally, some strobe devices for use with a camera or the like include an internal power supply (built-in battery or the like) for supplying electric power for flash light emission (namely, electric power for charging a main capacitor) and are also configured to be connectable with a large-capacity external power supply device (external battery pack or the like) so that the strobe device can receive electric power from outside when necessary.

It has been proposed to provide such a strobe device with a switch for allowing a user to select a power supply to be used (internal power supply or external power supply), and to stop operation of a voltage step-up circuit for raising the voltage of the internal power supply when input of external power is detected, such that supply of electric power from the internal power supply is stopped (see JP 2003-295268A).

However, in the conventional strobe device disclosed in JP 2003-295268A, it is necessary for the user to check the remaining battery power of the internal power supply and the external power supply, and operate the power supply selection switch appropriately, which is quite cumbersome. To address such a problem, it may be conceived to omit the switch so that electric power is supplied from both the internal power supply and the external power supply. However, in such a case, the electric power of the internal power supply, which has a relatively small capacity, tends to be consumed first and hence the internal power supply would require frequent charging (or frequent replacement of the battery).

Further, the strobe device disclosed in JP 2003-295268A includes an external power supply detection circuit dedicated to detection of input of external power to stop the operation of the voltage step-up circuit upon detection of the external power supply, and the dedicated circuit complicates the structure and increases the cost.

### SUMMARY OF THE INVENTION

In view of the aforementioned problems in the prior art, a primary object of the present invention is to provide a strobe device and an electric power supplying method therefor, such that, when an external power supply device is connected with the strobe device, electric power for flash light emission can be supplied appropriately from the external power supply or an internal power supply, without need for a switching operation by a user to select the power supply to be used and without need for a special circuit dedicated to detection of input of external power.

According to one aspect of the present invention, there is provided a strobe device configured to be connectable with an external power supply device to receive electric power for light emission from outside, including: a main capacitor for storing electric charge for light emission; an internal power supply for supplying electric power to the main capacitor; and a power supply control unit configured to control supply of electric power to the main capacitor, wherein the power supply control unit is configured to determine whether electric power is being supplied to the main capacitor from outside based on a change in a charge state of the main capacitor after a discharge of the main capacitor for light emission, and when it is determined that electric power is being supplied from outside, prevent the internal power supply from supplying electric power.

In the strobe device structured as above, when an external power supply device is connected with the strobe device and it is determined that electric power is being supplied from outside based on a change in the charge state of the main capacitor, supply of electric power from the internal power supply is prevented (namely, electric power is supplied only from the external power supply device having a relatively large capacity), and therefore, electric power for light emission can be supplied appropriately from the external power supply or the internal power supply, without need for a switching operation by a user to select the power supply to be used. Further, since the determination of whether electric power is being supplied from outside is performed based on a change in the charge state of the main capacitor, there is no need for a special circuit dedicated to detection of input of external power. It is to be noted that, if determination of whether electric power is being supplied to the main capacitor from outside is performed in a state where supply of electric power from the internal power supply is stopped, the determination accuracy can be improved.

Preferably, the strobe device further includes a voltage detector configured to detect a charge voltage of the main capacitor, wherein the power supply control unit is configured to determine whether electric power is being supplied to the main capacitor from outside based on a temporal change in the charge voltage of the main capacitor after the discharge of the main capacitor. Further preferably, the power supply control unit may be configured to determine that electric power is being supplied to the main capacitor from outside when a change rate of the charge voltage of the main capacitor for a predetermined time period after the discharge of the main capacitor exceeds a predetermined threshold value.

According to such a strobe device, it is possible to determine whether electric power is being supplied from outside based on the charge voltage of the main capacitor, which can be detected with a simple structure.

In a preferred embodiment, when the power supply control unit determines that electric power is being supplied from outside and the charge voltage of the main capacitor does not rise to a value higher than or equal to a reference voltage within a predetermined time period after determination that electric power is being supplied from outside, the power supply control unit is configured to stop preventing the internal power supply from supplying electric power and cause the internal power supply to start supplying electric power to the main capacitor.

According to such a structure, in a case where an external power supply device having a relatively low output voltage so as to be usable with various types of strobe devices having varying input voltage specs (rated input voltages), from 300 to 340 V, for example, when the main capacitor cannot be fully charged (namely, the charge voltage of the main capacitor does not reach the reference voltage) by the electric power from the external power supply device, supply of electric power from the internal power supply is added to fully charge the main capacitor. Thus, an external power supply device having an output voltage lower than the reference voltage of the main capacitor can be used with the strobe device to charge the main capacitor (partially) and suppress consumption of the internal power supply.

According to another aspect of the present invention, there is provided an electric power supplying method for a strobe device including a main capacitor for storing electric charge for light emission, and an internal power supply for supplying electric power to the main capacitor, the strobe device configured to be connectable with an external power supply device to receive electric power for light emission from outside, the method including: determining whether electric power is being supplied to the main capacitor from outside based on a change in a charge state of the main capacitor after a discharge of the main capacitor for light emission; and preventing supply of electric power from the internal power supply when it is determined that electric power is being supplied to the main capacitor from outside.

According to this electric power supplying method, when an external power supply device is connected with the strobe device and it is determined that electric power is being supplied from outside based on a change in the charge state of the main capacitor, supply of electric power from the internal power supply is prevented (namely, electric power is supplied only from the external power supply device having a relatively large capacity), and therefore, electric power for light emission can be supplied appropriately from the external power supply or the internal power supply, without need for a switching operation by a user to select the power supply to be used. Further, since the determination of whether electric power is being supplied from outside is performed based on a change in the charge state of the main capacitor, there is no need for a special circuit dedicated to detection of input of external power.

### BRIEF DESCRIPTION OF THE DRAWINGS

Now the present invention is described in the following in terms of preferred embodiment(s) thereof with reference to the appended drawings, in which:

FIG. 1 is a perspective view showing the appearance of a strobe device and an external power supply device in an embodiment of the present invention;

FIG. 2 is a schematic circuit diagram of the strobe device and the external power supply device according to the embodiment;

FIG. 3 is a flowchart showing an electric power supplying method in the strobe device according to the embodiment;

FIG. 4 is a diagram showing a first example of voltage change during charging of a main capacitor according to the embodiment; and

FIG. 5 is a diagram showing a second example of voltage change during charging of the main capacitor according to the embodiment.

### DETAILED DESCRIPTION OF THE PREFERRED EMBODIMENTS

Now, with reference to the appended drawings, description will be made of an embodiment of the present invention.

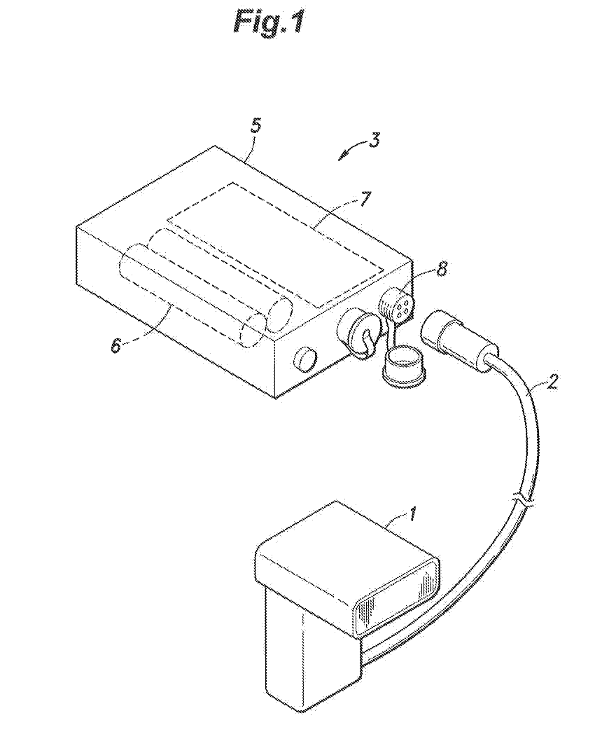

FIG. 1 is a perspective view showing the appearance of a strobe device according to an embodiment of the present invention and an external power supply device that can be connected with the strobe device. The strobe device 1 is an electronic flash device to be attached to a digital still camera (not shown in the drawings) when taking pictures, and is configured to be electrically connectable with the external power supply device 3 via a connection cable 2 to receive electric power for flash light emission or the like from outside. The external power supply device 3 includes an external battery 6 disposed in a casing 5 and serving as a power source, a control board 7 including a control circuit, etc., for controlling electric power supplied to the strobe device 1, and a strobe connection terminal 8 provided on a side surface of the casing 5.

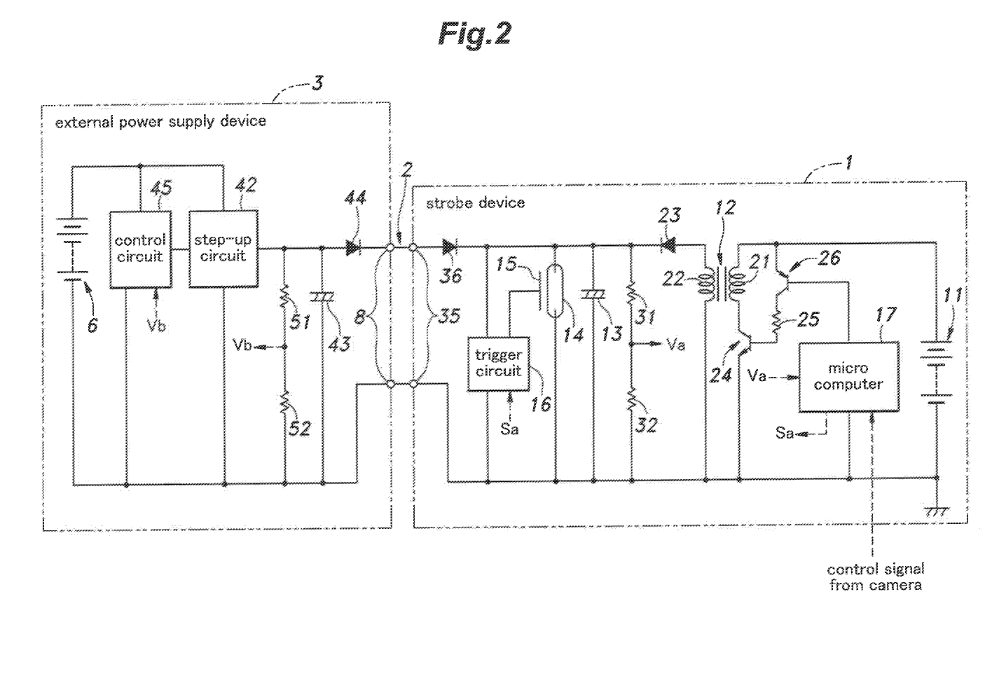

FIG. 2 is a schematic circuit diagram of the strobe device 1 and the external power supply device 3. The strobe device 1 includes a battery (internal power supply) 11 for supplying electric power for flash light emission, a step-up transformer 12 forming a step-up circuit for generating a high voltage by raising the battery voltage, a main capacitor 13 that is charged by the high voltage generated from the step-up transformer 12 (to store electric charge for light emission), a discharge tube 14 including a xenon tube configured to emit light when the electric charge stored in the main capacitor 13 is discharged therethrough, a trigger circuit 16 for applying a trigger voltage to a trigger electrode 15 of the discharge tube 14 to cause the discharge tube 14 to emit light, and a microcomputer (power supply control unit) 17 configured to control various operations of the strobe device 1 including the operation for supplying power from the internal battery 11 and the external battery 6 to the main capacitor 13.

The internal battery 11 consists of a secondary battery that is removably mounted to a main body of the strobe device 1. The step-up transformer 12 is configured to raise the voltage of the internal battery 11 (for example, 3V or 6V) when a switching current is caused to flow through a primary coil 21 thereof, such that a high (for example, 300-340V) alternating voltage is generated from a secondary coil 22 thereof. This alternating voltage is rectified by a rectifier diode 23 and is used to charge the main capacitor 13.

In the step-up transformer 12, one end of the primary coil 21 is connected with a positive terminal of the internal battery 11, while the other end of the primary coil 21 is connected with a collector of an oscillation transistor 24. The oscillation transistor 24 has an emitter connected to the ground and a base connected to a collector of a transistor 26 via a resister 25. The transistor 26 has an emitter connected with the positive terminal of the internal battery 11 and a base connected with a predetermined output port of the microcomputer 17. In such a configuration, the microcomputer 17 can control the supply of electric power to the main capacitor 13 from the internal battery 11 by controlling turning on and off of the oscillation transistor 24 by controlling a control signal output from the predetermined output port to the transistor 26.

Connected in parallel with the main capacitor 13 are resisters 31 and 32 to divide the output voltage of the secondary coil 22 of the step-up transformer 12. A voltage Va output from a node between the resisters 31 and 32 is input to the microcomputer 17. Based on the divided voltage Va, the microcomputer 17 can obtain information relating to the charge voltage of the main capacitor 13. Namely, the resisters 31 and 32 serve as a voltage detector that detects the charge voltage of the main capacitor. The microcomputer 17 includes a known comparator (voltage comparison) function and, by comparing the voltage Va with a predetermined reference voltage, can determine whether the charging of main capacitor 13 has completed. In a case where the external power supply unit 3 is not connected with the strobe device 1 and the main capacitor 13 is charged by use of the electric power from the internal battery 11 through the step-up transformer 12, when it is determined that the main capacitor 13 is sufficiently charged, the microcomputer 17 stops operation of the step-up circuit including the step-up transformer 12 by holding the transistor 26 (and hence, the transistor 24 also) off.

The trigger circuit 16 is a known circuit including a trigger capacitor, trigger transformer, thyristor, etc. (not shown in the drawings). The microcomputer 17 is configured to output a flashing command signal Sa from a predetermined output port in response to a control signal (such as a shutter button pressing signal, TTL signal, signal indicating opening/closing of the shutter, etc.) from a camera (not shown in the drawings) connected with the strobe device 1, thereby to activate the trigger circuit 16 (thyristor) at a predetermined timing. Upon activation on of the trigger circuit 16, the electric charge stored in the trigger capacitor is caused to flow through the trigger transformer to generate a raised voltage, which is applied to the trigger electrode 15, such that the gas such as xenon present in the discharge tube 14 is ionized and the discharge tube 14 is excited. This permits the electric charge accumulated in the main capacitor 13 to be discharged through the discharge tube 14, causing the discharge tube 14 to emit light.

The strobe device 1 is provided with an external power supply connection terminal 35 for connection with the strobe connection terminal 8 of the external power supply device 3. This allows the external power supply device 3 to supply electric current for charging the main capacitor 13 via a diode 36, which prevents electric current from flowing back to the external power supply device 3.

Further, the external power supply device 3 includes a battery (external power supply) 6 for supplying electric power for light emission, a step-up circuit 42 that, similarly to the step-up circuit in the strobe device 1, raises the battery voltage to generate a high voltage, a step-up capacitor 43 configured to be charged by the high voltage generated by the step-up circuit 42, a rectifier diode 44 that rectifies the high voltage output from the step-up circuit 42, and a control circuit 45 configured to control power supply to the strobe device 1 by controlling the charge voltage of the step-up capacitor 43.

Connected in parallel with the step-up capacitor 43 are resisters 51 and 52 for dividing the output voltage of the step-up circuit 42. A voltage Vb output from a node between the resisters 51 and 52 is input to the control circuit 45. Based on the divided voltage Vb, the control circuit 45 can obtain information on the charge voltage of the step-up capacitor 43. Further, by comparing the voltage Vb with a predetermined reference voltage, the control circuit 45 can determine whether the charge voltage of the step-up capacitor 43 is at an appropriate voltage. When the charge voltage of the step-up capacitor 43 has reached a reference voltage, the control circuit 45 turns off the step-up circuit 42, and when the charge voltage of the step-up capacitor 43 becomes below the reference voltage as a result of discharge of the step-up capacitor 43 (namely, charging of the main capacitor 13 in the strobe device 1), the control circuit 45 activates the step-up circuit 42. In this example, it is assumed that the reference voltage for the charge voltage of the step-up capacitor 43 is 300V, and the main capacitor 13 of the strobe device 1 is charged by this 300V voltage via the connection cable 2.

The external power supply device 3 is activated upon connection of the connection cable 2 with the strobe connection terminal 8, and starts supplying electric power to the strobe device 1 (charging of the main capacitor 13). Alternatively, the external power supply device 3 may be provided with a switch to be operated by a user to activate the external power supply device 3.

In the strobe device 1, when the external power supply device 3 is not connected, the microcomputer 17 performs control to charge the main capacitor 13 by use of the internal battery 11 in the manner as in a conventional strobe device (namely, the microcomputer 17 controls the operation of the step-up circuit including the step-up transformer 12 and transistors 24 and 25 such that the voltage of the main capacitor 13 detected through the divided voltage Va is at an appropriate voltage (reference voltage)). Further, the microcomputer 17 determines whether electric power is being supplied from the external power supply device 3 to the main capacitor 13 based on a change in the charge state of the main capacitor 13, and when it is determined that electric power is being supplied from the external power supply device 3 (namely, the external power supply device 3 is connected), prevents electric power supply from the internal battery 11, thereby to cause the external battery 6 to supply electric power with priority. In the following, detailed description will be given of such a power supplying operation in the strobe device 1.

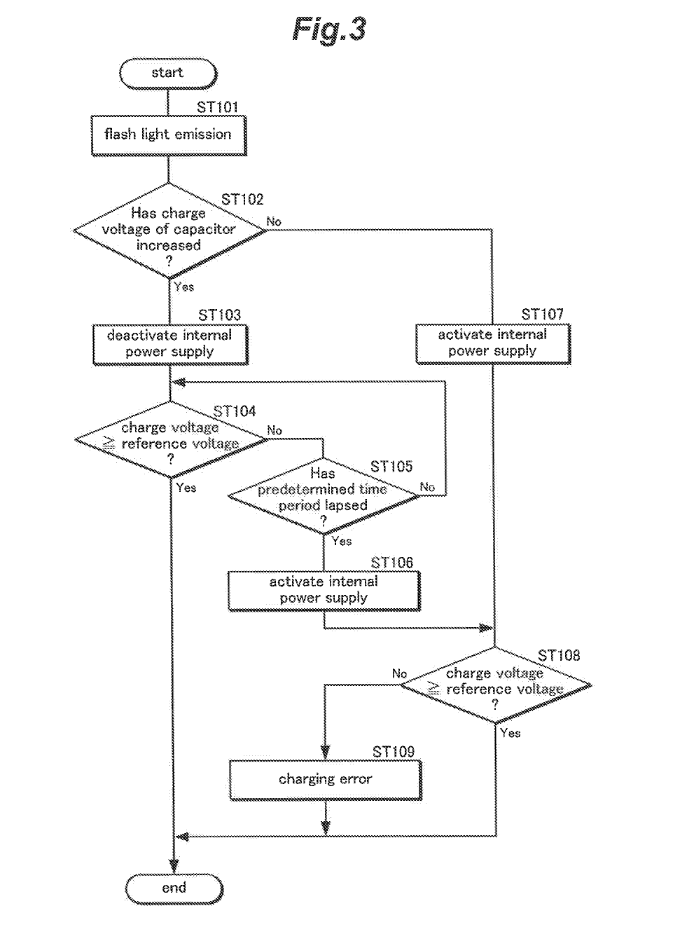

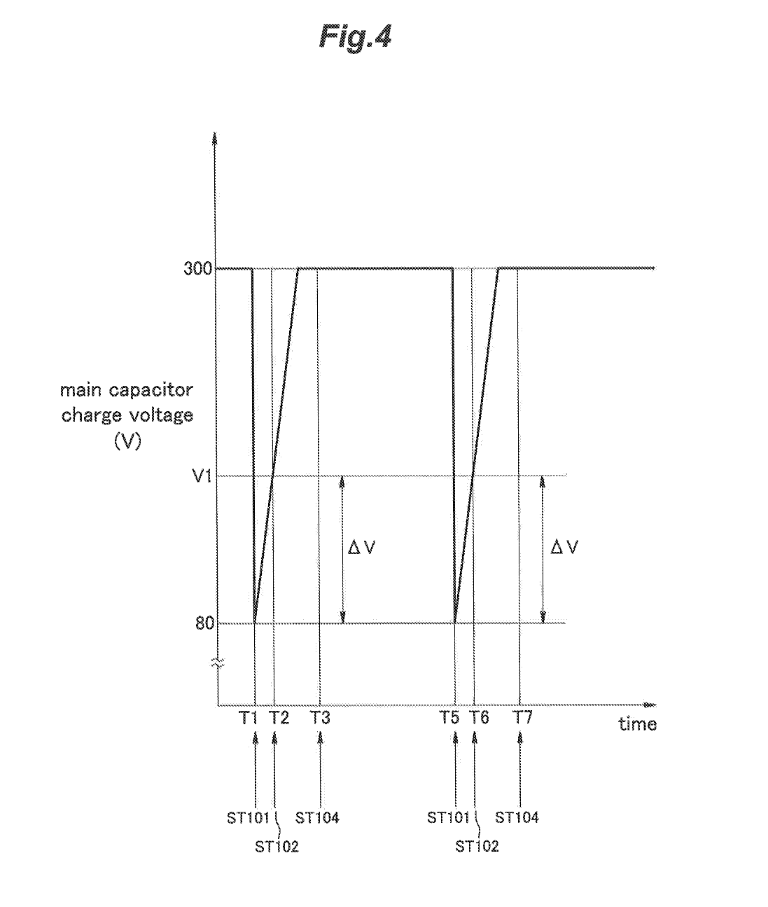

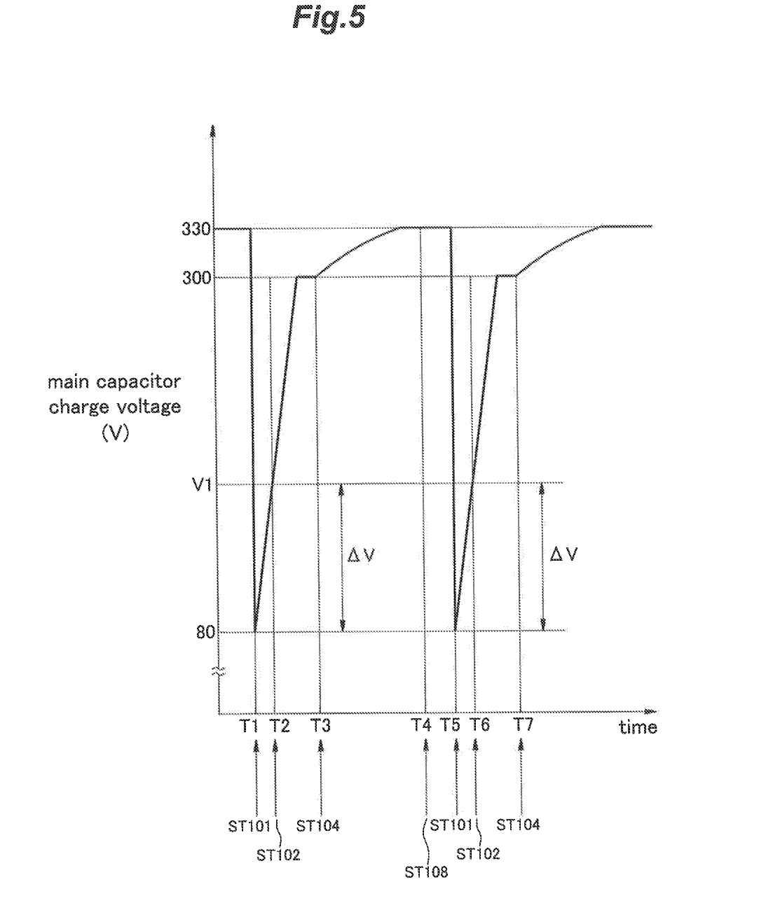

FIG. 3 is a flowchart showing an electric power supplying method in the strobe device (method of charging the main capacitor), and FIGS. 4 and 5 are diagrams showing first and second examples of voltage change during charging of the main capacitor, respectively. FIG. 4 shows an example in which the reference voltage (300V) for the charge voltage in the external power supply device 3 is the same as the reference voltage for the charge voltage of the main capacitor 13, while FIG. 5 shows an example in which the reference voltage (300V) in the external power supply device 3 is lower than the reference voltage (330V) of the main capacitor 13. It is to be noted that, to enable the strobe device 1 to emit flash light when pictures are taken with a camera, it is necessary to charge the main capacitor 13, the trigger capacitor and the like in advance, but description will be given here focusing on the charging of the main capacitor 13.

When the strobe device 1 emits flash light (ST101), the electric charge stored in the main capacitor 13 is discharged. It is to be noted that when the strobe device 1 is activated, the main capacitor 13 may be in a substantially discharged state, and in such a case, step ST101 may be skipped and the process may begin from the next step ST102.

In FIGS. 4 and 5, time T1 indicates the timing of flash light emission in step ST101, at which the charge voltage of the main capacitor 13 decreases from the reference voltage (in this example, 300V or 330V) in the fully charged state to a certain value (in this example, 80 V).

Next, the microcomputer 17 obtains information relating to the charge voltage of the main capacitor 13 (charge voltage detection step), and determines whether the charge voltage of the main capacitor 13 has increased during a predetermined time period (namely, assesses a temporal change in the charge state) (ST102). This step ST102 is a step for determining whether the external power supply device 3 is connected with the strobe device 1 (external power supply determination step), and is carried out based on a temporal change in the voltage Va. It is to be noted that the determination in step ST102 may be performed while electric power is being supplied from the internal battery 11 also, though the determination accuracy can be improved by performing the determination in a state where the supply of electric power from the internal battery 11 is stopped (the oscillation transistor 24 is kept off).

In FIGS. 4 and 5, time T2 indicates the timing of assessing increase in the charge voltage in step ST102. This assessment of increase in the charge voltage is performed by determining whether the time differential value of the voltage V1 (a change rate (or a change per unit time) derived from ΔV (=V1−80) in FIGS. 4 and 5) exceeds a predetermined threshold value. This may be also performed by determining whether the difference ΔV between the charge voltage (V1) at the time T2 and the charge voltage (80V) at the time T1 exceeds a predetermined threshold value. Also, it may be possible to perform the assessment of increase in the charge voltage not only at the time T2 but also at multiple timings to improve the determination accuracy.

If it is determined that the charge voltage of the main capacitor 13 has increased in step ST102 (ST102: Yes), the microcomputer 17 prevents supply of electric power from the internal battery 11 (ST103). In this step ST103 (internal power supply prevention step), the microcomputer 17 keeps the oscillation transistor 24 in an off state. As a result, electric power is supplied to the main capacitor 13 only from the external power supply device 3.

Subsequently, the microcomputer 17 acquires information regarding the charge voltage of the main capacitor 13, and determines whether the charge voltage has become higher than or equal to the reference voltage (namely, whether the charging has completed successfully) (ST104). The determination regarding the charge voltage in step ST104 is performed based on the voltage Va similarly as in step ST102.

In FIGS. 4 and 5, time T3 indicates the timing of determining whether the charge voltage has become higher than or equal to the predetermined reference voltage in step ST104. FIG. 4 shows a case in which the charge voltage reaches the reference voltage (300V) for the main capacitor 13 at the time T3 (namely, when a predetermined time has passed from the time T2). On the other hand, FIG. 5 shows a case in which the charge voltage has not reached the reference voltage (330V) for the main capacitor 13 at the time T3.

As in the case shown in FIG. 4, if it is determined in step ST104 that the charge voltage of the main capacitor 13 has become higher than or equal to the predetermined reference voltage at the time T3 (ST104: Yes), the operation of supplying electric power in the strobe device 1 is completed, and the strobe device 1 is ready for flash light emission.

On the other hand, if it is determined in step ST104 that the charge voltage of the main capacitor 13 has not reached the predetermined reference voltage at the time T3 as shown in FIG. 5 (namely, when the state that the charge voltage of the main capacitor 13 is below the predetermined reference voltage (ST104: No) continues for a predetermined time period (ST105: Yes)), the microcomputer 17 causes the internal battery 11 to start supplying electric power (starts turning on and off the oscillation transistor 24) (ST106). The charge voltage of the main capacitor 13 may not reach the reference voltage when the reference voltage (330V) for the main capacitor 13 is higher than the charge voltage (300V) of the external power supply device 3 as shown in FIG. 5 or when the external battery 6 in the external power supply device 3 has been consumed, for example.

Subsequently, the microcomputer 17 obtains information relating to the charge voltage of the main capacitor 13 similarly as in step ST104, and determines again whether the charge voltage has become higher than or equal to the reference voltage (ST108). In FIG. 5, time T4 indicates the timing of determining whether the charge voltage has become higher than or equal to the predetermined reference voltage in step ST108. If it is determined in step ST108 that the charge voltage of the main capacitor 13 has become higher than or equal to the predetermined reference voltage at the time T4 (namely, when a predetermined time has passed from the time T3) (ST108: Yes), the operation of supplying electric power in the strobe device 1 is completed, and the strobe device 1 becomes ready for flash light emission. On the other hand, if the charge voltage is lower than the predetermined reference voltage at the time T4, the microcomputer 17 determines that the main capacitor 13 cannot be charged normally, and indicates the error to the user by causing a display lamp to blink, for example (ST109). It is to be noted that if the determination in step ST104 and/or the determination in ST108 are performed not only at the times T3 and T4 but also at additional timings, it is possible to improve the determination accuracy.

Further, if it is determined in step ST 102 that the charge voltage of the main capacitor 13 has not increased (ST102: No), the microcomputer 17 causes the internal battery 11 to start supplying electric power at step ST107, as in step ST106. Thereafter, the process proceeds to step ST108, and the steps described above are executed.

The above described steps are executed each time flash light is emitted from the strobe device 1 (or upon activation of the strobe device 1). In FIGS. 4 and 5, times T5, T6 and T7 relating to the next flash light emission respectively correspond to the times T1, T2 and T3 relating to the above-described (previous) flash light emission, Further, the temporal change in the charge voltage of the main capacitor 13 relating to the next flash light emission is shown as being substantially identical with the change in the charge voltage of the main capacitor 13 relating to the previous flash light emission. However, the amount of decrease in the charge voltage of the main capacitor 13 as a result of flash light emission may vary depending on an amount of flash light emitted, and thus, the temporal change in the charge voltage of the main capacitor 13 may not be the same for every flash light emission.

As described in the foregoing, the strobe device 1 is configured such that it is determined automatically whether electric power is being supplied to the main capacitor 13 from the external power supply device 3 based on a change in the charge state of the main capacitor 13, and if it is determined that electric power is being supplied externally, supply of electric power from the internal battery 11 is prevented (so that electric power is supplied only from the external battery 6 having a relatively large capacity). This enables electric power for light emission to be supplied appropriately from the internal battery 11 or the external battery 6, without need for a switching operation by a user to select the power supply (battery) to be used and without need for a special circuit dedicated to detection of input of electric power from the external power supply device 3. Therefore, it is possible to avoid a problem that the electric power of the internal battery 11, which has a relatively small capacity, tends to be consumed first and hence the internal battery 11 would require frequent charging (or frequent replacement).

Although the present invention has been described in terms of a preferred embodiment thereof, it is obvious to a person skilled in the art that various alterations and modifications are possible without departing from the scope of the present invention which is set forth in the appended claims. For example, in the above-described strobe device, the change in the charge state of the main capacitor is evaluated based on the temporal change of the charge voltage of the main capacitor. However, the strobe device may be configured to include a means for detecting a charge current flowing into the main capacitor and determine whether the external power supply device is connected depending on the temporal change in the charge current. It is also to be noted that not all of the structural elements shown in the embodiment relating to the strobe device and the electric power supplying method of the present invention are necessarily indispensable, and they may be selectively used as appropriate without departing from the spirit of the present invention.

The contents of the original Japanese patent application (Japanese Patent Application No. 2012-240168) on which the Paris Convention priority claim is made for the present application as well as the contents of the prior art references mentioned in this application are incorporated in this application by reference.

1. A strobe device configured to be connectable with an external power supply device to receive electric power for light emission from outside, comprising:
a main capacitor for storing electric charge for light emission;
an internal power supply for supplying electric power to the main capacitor; and
a power supply control unit configured to control supply of electric power to the main capacitor,
wherein the power supply control unit is configured to determine whether electric power is being supplied to the main capacitor from outside based on a change in a charge state of the main capacitor after a discharge of the main capacitor for light emission, and when it is determined that electric power is being supplied from outside, prevent the internal power supply from supplying electric power.

2. The strobe device according to claim 1, further comprising a voltage detector configured to detect a charge voltage of the main capacitor, wherein the power supply control unit is configured to determine whether electric power is being supplied to the main capacitor from outside based on a temporal change in the charge voltage of the main capacitor after the discharge of the main capacitor.

3. The strobe device according to claim 2, wherein when the power supply control unit determines that electric power is being supplied from outside and the charge voltage of the main capacitor does not rise to a value higher than or equal to a reference voltage within a predetermined time period after determination that electric power is being supplied from outside, the power supply control unit is configured to stop preventing the internal power supply from supplying electric power and cause the internal power supply to start supplying electric power to the main capacitor.

4. The strobe device according to claim 2, wherein the power supply control unit is configured to determine that electric power is being supplied to the main capacitor from outside when a change rate of the charge voltage of the main capacitor for a predetermined time period after the discharge of the main capacitor exceeds a predetermined threshold value.

5. The strobe device according to claim 1, wherein the power supply control unit is configured to stop supply of electric power from the internal power supply to the main capacitor while performing determination of whether electric power is being supplied to the main capacitor from outside.

6. An electric power supplying method for a strobe device comprising a main capacitor for storing electric charge for light emission, and an internal power supply for supplying electric power to the main capacitor, the strobe device configured to be connectable with an external power supply device to receive electric power for light emission from outside,
the method comprising:
determining whether electric power is being supplied to the main capacitor from outside based on a change in a charge state of the main capacitor after a discharge of the main capacitor for light emission; and
preventing supply of electric power from the internal power supply when it is determined that electric power is being supplied to the main capacitor from outside.
